(19) United States
(12) Patent Application Publication
(10) Pub. No.: US 2014/0339226 A1
(43) Pub. Date: Nov. 20, 2014

(54) Convenient Side-Door Bin

(71) Applicants: Charmin Katherine Edwards, Chicago, IL (US); Shayon Charles Harris, Chicago (US)

(72) Inventors: Charmin Katherine Edwards, Chicago, IL (US); Shayon Charles Harris, Chicago (US)

(21) Appl. No.: 14/279,285

(22) Filed: May 15, 2014

Related U.S. Application Data
(60) Provisional application No. 61/823,487, filed on May 15, 2013.

(51) Int. Cl. B65F 1/06; B65F 1/12

(52) U.S. Cl. CPC B65F 1/068; B65F 1/12; B65F 2220/108
USPC 220/4.23; 220/495.08

(57) ABSTRACT

An apparatus includes an upright housing having a uniform cavity and an open top. A flat base of said upright housing defines an enclosure for containing trash. An arcuate door engages with a vertical axis of the upright housing via a hinge. The arcuate door swings about the hinge away from the upright housing. A latch secures said door in a closed position upon closing of said door.

### CROSS-REFERENCE TO RELATED APPLICATIONS

This is a nonprovisional application of the provisional application having Ser. No. 61/823,487 filed on May 15, 2013, whose disclosure is incorporated herein by reference in its entirety.

### BACKGROUND

The present invention relates generally to trash or garbage containers for holding garbage in bags which may be secured around the rim of the container.

Garbage containers are known in the prior art. Typically, such containers include an open-topped housing of square or round cross-section, with a top lid that can be removed manually by hand or with a hinge. In one example, the hinge includes a vertically-oriented piano-type hinge engaging with the door and the body. While a number of relatively many garbage container designs are found in the prior art, they suffer from a number of disadvantages. Common problem with trash containers of all sizes is that the polyethylene film bags usually used to collect trash within a container can tend to stick to the sides of the plastic trash can when full and can get heavy, making them difficult to lift up out of the can. Thus, remover must use substantially vertical force to lift the garbage bag upwardly through a distance of four feet or more in order to clear the rim of the trash can. This motion can causes excessive back strain and may result in back injuries. This creates hassles for everyday life, especially for people with disability, elderly and children.

Some prior art describes a pedal operated garbage container to open the lid. Another type describes a square garbage container with a front wall opening, pivoted at its lower end to the front end of the lower wall, to pivot downwardly into the open position. The lower wall with a portion projecting forwardly from the front edges and the projecting portion has a peripheral, upwardly projecting rim to resist leakage.

### SUMMRY OF THE INVENTION

Aspects of the invention overcome the shortcomings of prior art and provides a receptacle assembly which comprises a housing having an arcuate door to provide an easier access for removal for a filled trash bag. In one example, a trash container includes a housing having a vertical body and an arcuate door, and the housing has an open top and a front opening extending from the container body and sideway. The arcuate door is disposed in the vertical body, and the door includes a substantially 180 degree arcuate section of the body. A hinge and mounting structure for the door is provided for pivotally mounting and cantilevering the door about a substantially vertical axis to swing outwardly into the open position and can be secured by a locking mechanism in a close position.

In another embodiment, the bottom member of the garbage container is at the same level as the floor without any projecting rim that prevents the smooth transition of the bag onto the floor so that it provides the protection from the unintended scratch or breakage. Thus, trash container of this invention makes access and removal of a full garbage bag much easier than in a conventional trash can.

In another embodiment, an apparatus includes a bin having a body and a removable lid. The body includes a cavity for receiving objects. The body includes a door, and the door pivotably engaging a hinge, with the door vertically rotating about the hinge. The bin also includes a latch for securing the door in a closed position to the body of the bin. For example, the latch includes a leaf spring cantilevered from an interior surface of the body. The body also has a base and a footing is disposed at the base of the body.

In a further embodiment, an apparatus includes a bin having a body and a removable lid. The body includes a cavity for receiving objects. The body includes a door, and the door pivotably engaging a hinge, with the door vertically rotating about the hinge. The bin also includes a latch for securing the door in a closed position to the body of the bin. The body also has a base and a footing is disposed at the base of the body. The footing includes a semi-circle protrusion. An upright background is vertically retractably extending over the body.

### BREIF DESCRIPTION OF THE DRAWINGS

The present invention will be better understood from the following detailed description of some preferred embodiments of the present invention, taken in conjunction with the accompanying drawings, in which like reference numerals refer to like parts, and in which:

FIGS. 1A-1B are side views of a container according to one embodiment of the invention.

FIG. 2 is an illustration of an interior of a container according to one embodiment of the invention.

FIG. 3 is a perspective view of a lid for a container according to one embodiment of the invention.

FIG. 4 is a perspective view of an alternative attachment to a container according to one embodiment of the invention.

FIGS. 5A-5F are bottom views of placements of wheels on a container according to one embodiment of the invention.

FIGS. 6A-6H are cross-sections of a shape of a container according to one embodiment of the invention.

Corresponding reference characters indicate corresponding parts throughout the drawings.

### DETAILED DESCRIPTION

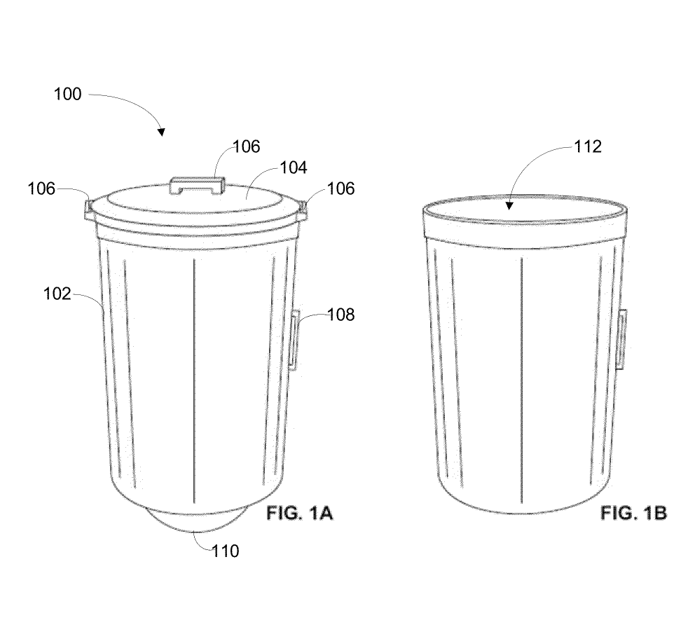

Referring to FIGS. 1A and 1B, side views of a container or bin 100 according to one embodiment of the invention. In one embodiment, the bin 100 may be a container or a receptacle. In another embodiment, the bin 100 may be a trash can or a trash bin. In a further embodiment, the bin 100 may be standalone trash can capable of other multi-functional features and uses. In another embodiment, the bin 100 may be made of a high strength plastic-base materials to provide both lightweight and strength to the bin 100. It is to be understood that other materials maybe used without departing from the scope and spirit of the invention.

Still referring to FIG. 1A, the bin 100 includes a body 102, a lid 104, and lid handles 106. The bin 100 also includes a door handle 108 and a footing 110. FIG. 1B illustrates after the lid 104 is removed and the bin 100 has an interior receiving chamber or space 112. Furthermore, FIG. 3 shows a perspective view of the lid 104 with the lid handles 106. For example, FIG. 3 illustrates the three lid handles 106: one on the top of the lid 104 and two side handles 106 disposed on the opposite sides of the lid 104. It is to be understood that the shape of the lid 104 is not limited to a circular shape.

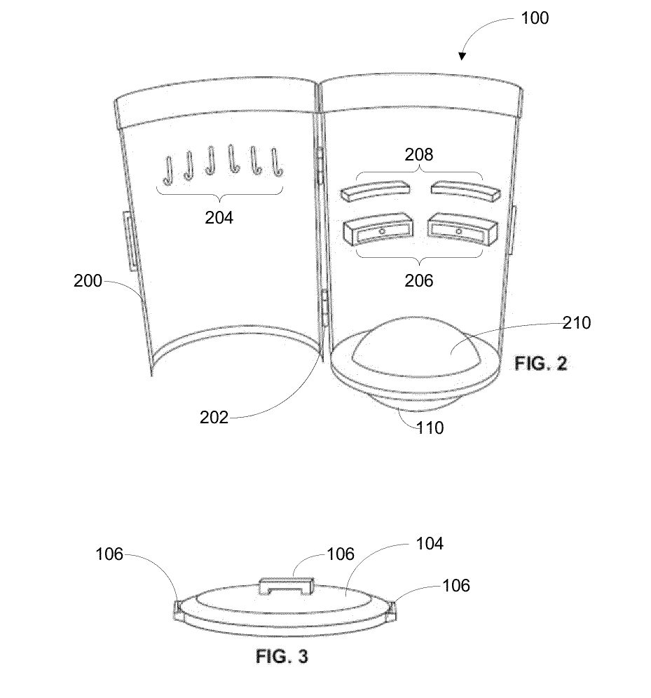

Referring now to FIG. 2, a view shows the interior receiving chamber 112 in more detail according to one embodiment of the invention. In one embodiment, the chamber 112 is exposed or opened when a door 200 of the bin 100 opens. The door 200 rotates about or pivotably engages hinges 202. In one embodiment, the door 200 latches to the body 102 at or near where the door handle 108 is. It is to be understood that numerous mechanisms may be used as a latching mechanism without departing from the scope or spirit of the invention. In this embodiment, the door 200 is swung open toward a user as the user pulls the door handle 108. As such, as the user deposits items through opening after the lid is removed, such as trash into the bin 100, the same items may be easily removed from the bin 100 from the side of the bin 100 through the opening of the door 200.

In addition to temporarily storing trash in the bin 100, the bin 100 may hold other items as a storage cabinet. For example, the bin 100 includes one or more hanging hooks 204 disposed on an interior surface of the door 200. Similarly, in an interior surface of the bin 100, the bin 100 includes one or more shelves 206 and 208 of different sizes and shapes. It is understood that locations and placements of hooks 204 and shelves 206 and 208 may be disposed at different locations in the interior of the bin 100 or in the chamber 112 without departing from the spirit or scope of the invention. It is also understood that the weight of items supported by the hooks 204 and shelves 206 and 208 will be appropriately distributed such that the bin 100 will not become unstable.

The bin 100 also includes the footing 110. In one embodiment, the footing 100 includes a circular protrusion that has a limited surface area contacting the ground surface. In one embodiment, the limited surface area is smaller than the bottom surface area of the bin 100. As such, with the limited surface area, the user is able to pull, push or move the bin 100 with relatively ease. For example, the user is able to hold the bin 100 on the rims of the body 102 after the lid 104 is removed and apply force to the bin 100 to move the bin 100 to any desirable location. With the circular protrusion embodiment, a base structure 210 is disposed within the chamber 112 and provides weight to lower the center of gravity.

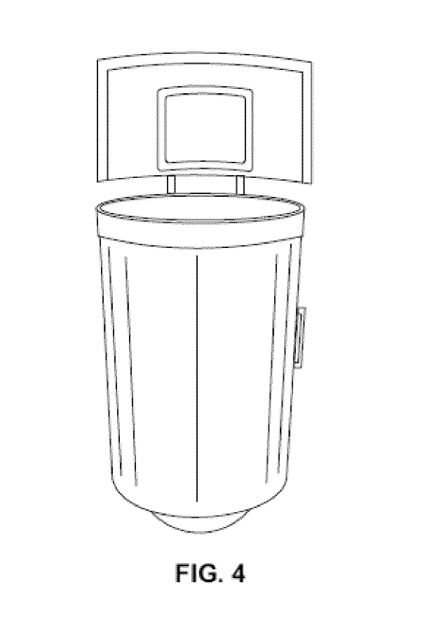

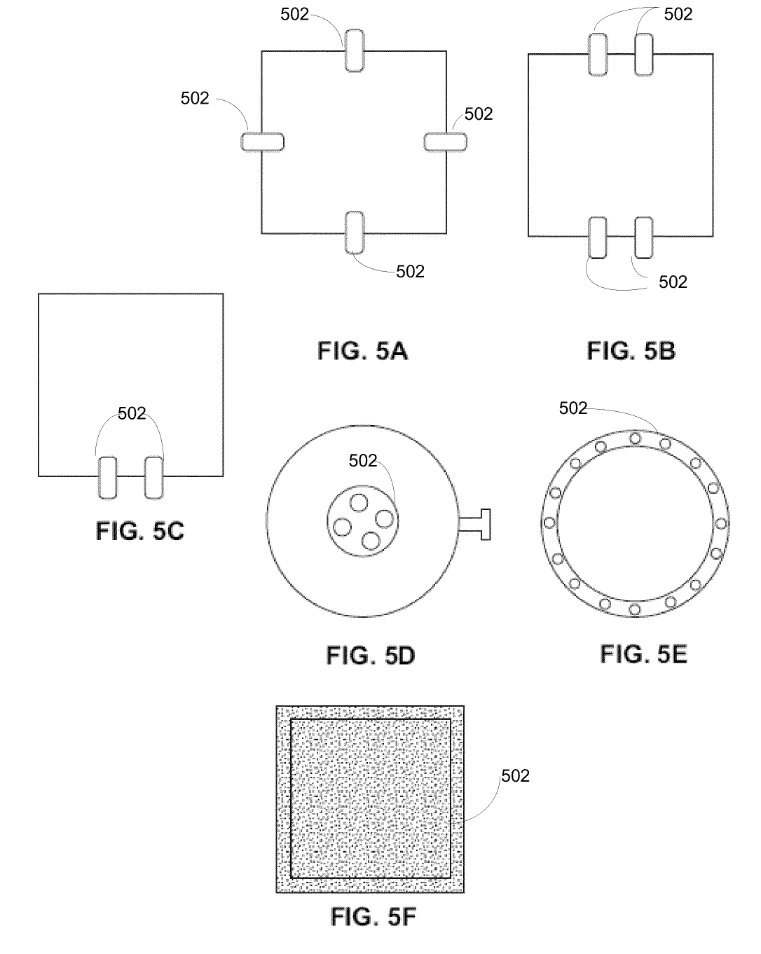

Referring now to FIGS. 5A to 5F, a series of figures showing different figurations of the footing 110. For example, wheels 502 may be disposed at various locations on the bottom surface of the exterior of the bin 100 as shown FIGS. 5A to 5F.

Referring to FIG. 4, an illustration of another embodiment of the bin 100. For example, the bin 100 includes an accessory 402 such as a backboard. In this embodiment, the accessory 402 is attached to the exterior surface of the body 102 of the bin 100. The accessory 402 is used to block or prevent any overthrown objects over the top of the bin 100 such that the objects would fall into the chamber 112 as the accessory 402 stops the movement of the objects. In another embodiment, when the bin 100 is used as a toy for a young child, the accessory 402 may be used as a ball backboard such that the bin 100 is treated as a basket. As such, the ball after thrown against the accessory 402 will fall into the chamber 112 and the ball may be retrieved through the opening of the door 200. As such, with the side-opening door 200, the bin 100 becomes a versatile bin or container that serves multiple purposes for elderly or disabled to remove trash or items from the door 200 and young children to add or append attachments or accessories to the bin 200.

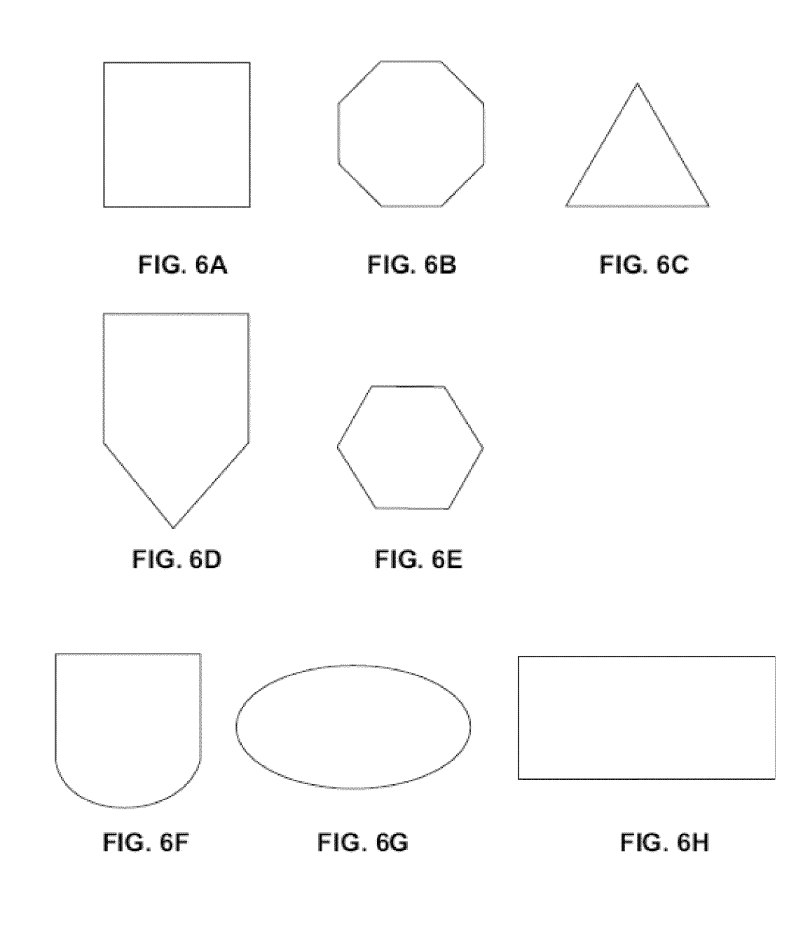

In a further example, FIGS. 6A to 6H illustrate different cross-section shapes of the body 102 of the bin 100 in addition to the cylindrical shape shown in FIGS. 1 to 4. For example, FIG. 6A is a square, FIG. 6B is an octagon, FIG. 6C is a triangle, FIG. 6D is a baseball base-plate shape, FIG. 6E is hexagon, FIG. 6F is modified square with a side with curved line, FIG. 6G is oval, and FIG. 6H is a rectangle. It is to be understood that other polygon shapes may be used without departing from the scope or spirit of the invention.

When introducing elements or aspects of the invention or the embodiments thereof, the articles “a,” “an,” “the,” and “said” are intended to mean that there are one or more of the elements. The terms “including,” and “having” are intended to be inclusive and mean that there may be additional elements other than the listed elements.

Having described aspects of the invention in detail, it will be apparent that modifications and variations are possible without departing from the scope or aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

We claim:

1. An apparatus comprising:
a bin having a body and a removable lid;
said body comprising a cavity for receiving objects;
said body having a door, said door pivotably engaging a hinge, said door vertically rotating about the hinge;
a latch for securing said door in a closed position to the body of the bin;
said body having a base; and
a footing disposed at the base of the body.

2. The apparatus as claimed in claim 1, wherein the body comprises a cylindrical shape.

3. The apparatus as claimed in claim 1, further comprising a moving element for engaging the footing.

4. The apparatus as claimed in claim 3, wherein said moving element comprises wheels.

5. The apparatus as claimed in claim 3, wherein said moving element comprises a semi-circle protrusion.

6. The apparatus as claimed in claim 1, wherein the hinge comprises a vertically-oriented piano-type hinge engaged with the door and the body.

7. The apparatus as claimed in claim 1, wherein said latch comprises a leaf spring cantilevered from an interior surface of said body.

8. A device comprising:
a bin having a body and a removable lid;
said body comprising a cavity for receiving objects;
said body having a door, said door pivotably engaging a hinge, said door vertically rotating about the hinge;
a latch for securing said door in a closed position to the body of the bin;
said body having a base; and
a footing disposed at the base of the body, said footing comprises a semi-circle protrusion.

9. The device as claimed in claim 8, wherein the body comprises a cylindrical shape.

10. The device as claimed in claim 8, further comprising a moving element for engaging the footing.

11. The device as claimed in claim 10, wherein said moving element comprises wheels.

12. The device as claimed in claim 8, wherein the hinge comprises a vertically-oriented piano-type hinge engaged with the door and the body.

13. The device as claimed in claim 8, wherein said latch comprises a leaf spring cantilevered from an interior surface of said body.

14. The device as claimed in claim 8, further comprising a lock element corresponding to the latch for securing the door to the body.

15. The device as claimed in claim 8, further comprising an upright backboard vertically retractably extending over the body.

16. The device as claimed in claim 8, wherein the door comprises two panels, each of the two panels pivotably engaged with the body, said each of the two panels having a member latch for securing to the body.

17. An apparatus comprising:
a bin having a body and a removable lid;
said body comprising a cavity for receiving objects;
said body having a door, said door pivotably engaging a hinge, said door vertically rotating about the hinge;
a latch for securing said door in a closed position to the body of the bin;
said body having a base;
a footing disposed at the base of the body, said footing comprises a semi-circle protrusion; and
an upright background vertically retractably extending over the body.

18. The apparatus as claimed in claim 17, wherein the door comprises two panels, each of the two panels pivotably engaged with the body, said each of the two panels having a member latch for securing to the body.

19. The device as claimed in claim 10, wherein said moving element comprises wheels.

20. The device as claimed in claim 8, wherein the hinge comprises a vertically-oriented piano-type hinge engaged with the door and the body.
